(19) United States
(12) Patent Application Publication
(10) Pub. No.: US 2010/0315399 A1
(43) Pub. Date: Dec. 16, 2010

(54) Flexible Electronic Device and Method of Manufacture

(76) Inventors: Joseph M. Jacobson, Newton, MA (US); Serge Rutman, Boulder Creek, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/481,677

(22) Filed: Jun. 10, 2009

(51) Int. Cl. G09G 5/00; B32B 37/00; G09G 3/20

(52) U.S. Cl. 345/211; 156/60; 345/55

(57) ABSTRACT

A flexible electronic device and method of manufacture are disclosed. According to one embodiment of the present invention, a flexible electronic device includes a front; a back; and a plurality of layers disposed between the front and the back. A plurality of components, including processor, a memory, a display, a display driver, a battery, and a data interface, may be disposed on the layers. The flexible electronic device may also include a plurality of flex points so that the flexible electronic device can be flexed relative to each flex point. According to another embodiment of the invention, the method of manufacturing a flexible electronic device by lamination includes (1) providing a first source of front layers for the flexible electronic device; (2) providing a second source of back layers for the flexible electronic device; (3) providing a source for each interior layer of the flexible electronic device, at least one interior layer having at least one flexible electronic component disposed thereon; (4) pressing the front, interior, and back layers together, resulting in a laminate; and (5) curing the laminate.

### BACKGROUND OF THE INVENTION

1. Field of the Invention

The present invention generally relates to an electronic device, and, more particularly, to a flexible electronic device and method of manufacture.

2. Description of the Related Art

In today's world, electronic devices are ubiquitous. In many cases, electronic devices have replaced traditional, non-electronic devices. For example, for many, electronic reading devices have replaced traditional paper books. An example of such a device is Amazon's Kindle wireless reading device, which allows a user to download an electronic book, and then read that book using the device. Another example of a similar product is the Plastic Logic Reader. These devices, while providing functionality for the user, still resemble small, inflexible computers.

### SUMMARY OF THE INVENTION

A flexible electronic device and method of manufacture are disclosed. According to one embodiment of the present invention, a flexible electronic device includes a front; a back; and a plurality of layers disposed between the front and the back. A plurality of components, including processor, a memory, a display, a display driver, a battery, and a data interface, may be disposed on the layers. The flexible electronic device may also include a plurality of flex points so that the flexible electronic device can be flexed relative to each flex point.

In one embodiment, one of the plurality of components may be an inflexible component, and that inflexible component may be positioned between flex points. In another embodiment, at least one of the components may be a thinned component.

In one embodiment, the battery may be charged by induction.

The flexible device may also include a flex limitation device. The flex limitation device may be disposed across at least one of the flex points, and may be a strain gauge, a carbon fiber string, etc.

In one embodiment, the flexible electronic device may include a piezoelectric strip that generates power when the flexible electronic device is flexed.

The flexible electronic device may be partially or completely hermetically sealed.

In one embodiment, the data interface may use inductive coupling to communicate.

The flexible electronic device may also include a speaker. The speaker may be provided with an audio resonant cavity, which may be formed in one of the layers.

In one embodiment, one of the layers maybe an adhesive layer. Further, one of the layers may be a shock absorption layer.

According to another embodiment of the invention, a method of manufacturing a flexible electronic device by lamination is disclosed. The method includes (1) providing a first source of front layers for the flexible electronic device; (2) providing a second source of back layers for the flexible electronic device; (3) providing a source for each interior layer of the flexible electronic device, at least one interior layer having at least one flexible electronic component disposed thereon; (4) pressing the front, interior, and back layers together, resulting in a laminate; and (5) curing the laminate.

In one embodiment, at least one of the interior layers includes an inflexible component disposed between flex points on the interior layer.

In another embodiment, the interior layers may include a processor, a memory, a display, a display driver, a battery, and a data interface.

In one embodiment, the battery may be disposed among a plurality of the interior layers.

One of the interior layers may include a flex limitation device disposed across at least one of the flex points. Further, one of the interior layers may include at least one piezoelectric strip that generates power when the flexible electronic device is flexed.

According to another embodiment, a laminate flexible electronic device is disclosed. The laminate flexible electronic device may include a front layer; a back layer; a plurality of interior layers disposed between the front layer and the back layer; and a plurality of components including at least a processor, a memory, a display, a display driver, a battery, and a data interface. The front layer, the interior layers, and the back layer are laminated together.

It is a technical advantage of the present invention that a flexible electronic device and method of manufacture are disclosed. It is another technical advantage of the present invention that a flexible electronic device includes flex points so that the flexible electronic device can be flexed relative to those flex points. It is yet another technical advantage of the present invention that the flexible electronic device may include inflexible components between flex points. It is still another technical advantage of the present invention that a flexible electronic device may be manufactured using a lamination process.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an illustration of a flexible electronic device according to one embodiment of the present invention;

FIGS. 2a and 2b are block diagrams of a flexible electronic device according to embodiments of the present invention;

FIG. 3 is a block diagram of a flexible electronic device according to an embodiment of the present invention;

FIGS. 4a and 4b are illustrations of a carbon fiber string according to an embodiment of the present invention;

FIG. 5 is a block diagram of a flexible electronic reading device according to an embodiment of the present invention;

FIG. 6 is a flowchart depicting a method of manufacture of a flexible electronic device according to an embodiment of the present invention;

FIG. 7 is a depiction of a layered flexible electronic device according to an embodiment of the present invention; and

FIG. 8 is a depiction of a system for manufacture by lamination according to one embodiment of the present invention.

### DETAILED DESCRIPTION OF PREFERRED EMBODIMENTS

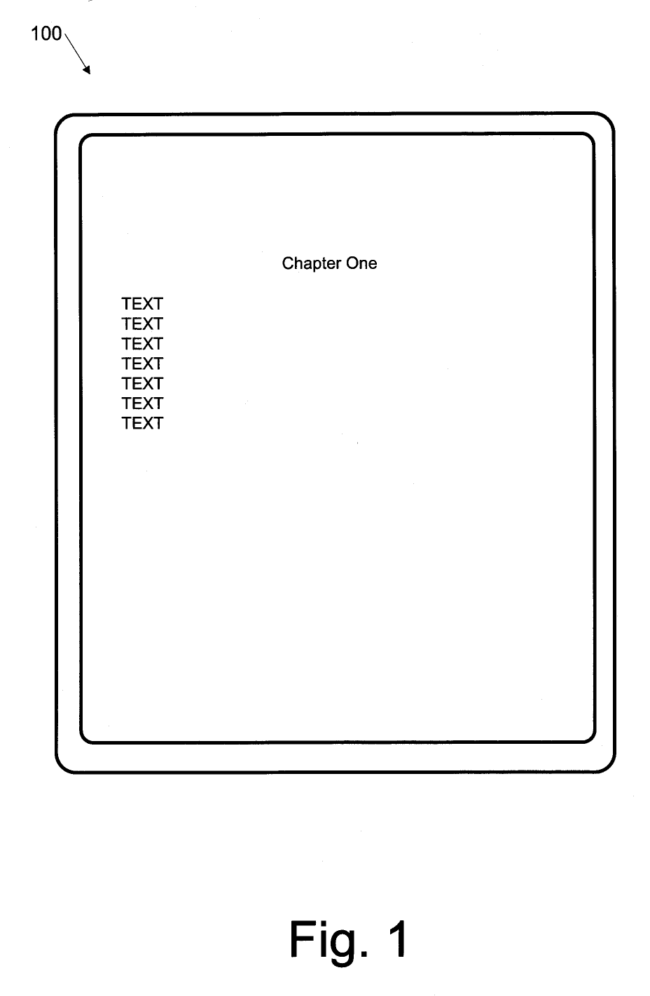

Several embodiments of the present invention and their advantages may be understood by referring to FIGS. 1-8, wherein like reference numerals refer to like elements.

Referring to FIG. 1, an illustration of a flexible electronic device according to one embodiment of the present invention is provided. Although the present invention is described in the context of an electronic book, it should be recognized that the present invention is not so limited. Indeed, the present invention has applications as other electronic devices, including laptop computers, displays, telephones, remote controls, digital cameras, digital camcorders, personal digital assistants (PDAs), music players, portable video players, video game machines and controllers, etc.

In general, flexible electronic device 100 may include components that are made of flexible materials, are rigid but have small dimensions, are rigid but can be placed on an area of the device that is less susceptible to bending, or have been “thinned.” Examples of flexible materials include plastics, polymers, gels, thin metals, etc. Examples of components that are rigid but may have small dimensions include microprocessors and memory. Examples of thinned silicon devices include display driver chips and microprocessors.

In one embodiment, a flexible device may be manufactured as a laminate of several layers. In between each layer, or several layers, may be disposed a shock absorbing layer. In one embodiment, the shock absorbing layer may comprise a visco-elastic polymer. An example visco-elastic is Sorbothane®, available from Sorbothane, Inc., Kent, Ohio. Other gels, such as those used for shock absorption in microdrives, may also be used.

In one embodiment, an adhesive may be provided between each layer or several layers. Several types of adhesives may be used, alone or in combination, to produce the laminate. In one embodiment, different adhesives may be used to bond different layers, different locations, etc. as necessary and/or desired. For example, different electronic components may have different tolerances for heat. Thus, an adhesive that requires an elevated temperature may not be compatible with a particular electronic component, and would not be used in that layer or area of the flexible electronic device.

Examples of adhesives that may be used include thermoadhesives, RF-cured adhesives, two part adhesives (e.g., epoxy), UV-cured adhesives, air-cured adhesives, etc. Other types of adhesives may be used as necessary and/or desired.

In one embodiment, an anisotropic conducting adhesive may be used between electrical components and/or printed circuit boards to allow electrical communication between those devices. For example, suitable anisotropic conducting adhesives and films are available from 3M, St. Paul, Minn.

In one embodiment, the gel that is provided for cushioning may also have adhesive properties or functionalities. Thus, the gel (or combination of gels) may provide multiple functions.

According to one embodiment of the present invention, the flexible electronic device may be substantially hermetically sealed. For example, a one-way valve or vent may be provided as necessary in the area of the rechargeable battery to release gas that may accumulate as the battery discharges.

In another embodiment, the flexible electronic device may be completely hermetically sealed.

In one embodiment, the flexible electronic device may be sealed by mechanical fastening. For example, the edges of the flexible electronic device may be crimped, welded, etc. Other types of mechanical fastening may be used as necessary and/or desired.

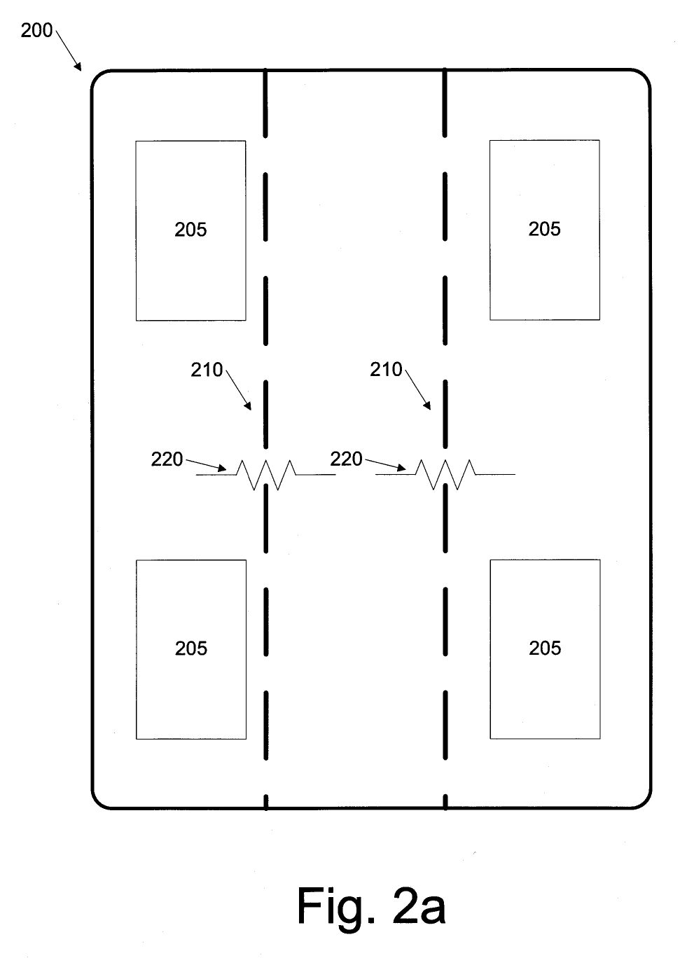

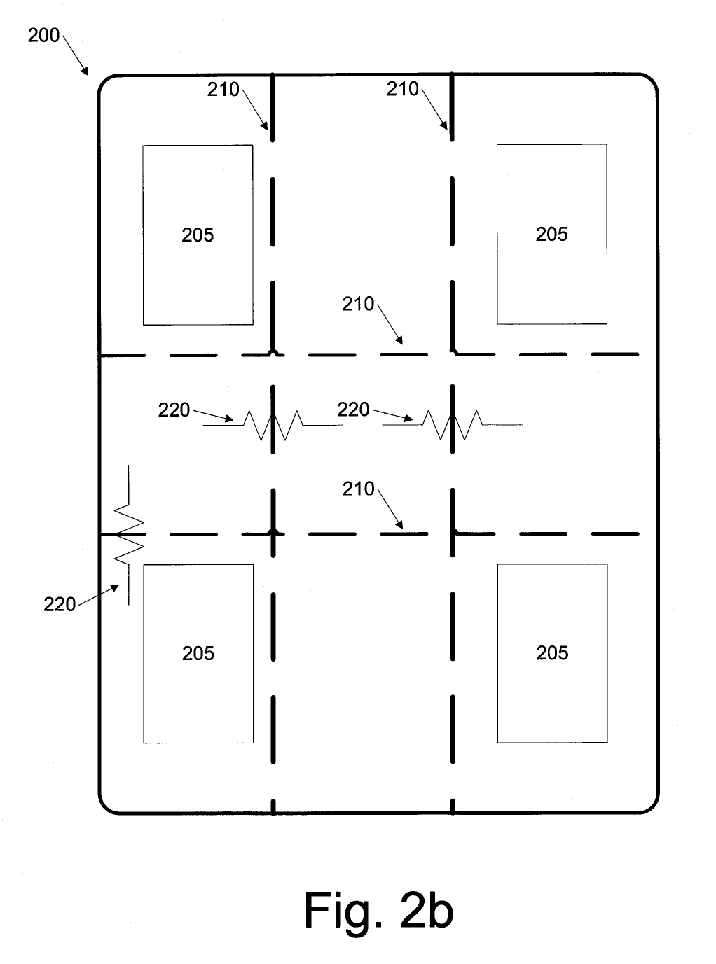

As noted above, the present invention is directed to a flexible electronic device. FIGS. 2a and 2b provide general examples of how flexibility may be achieved. Referring to FIG. 2a, flexible electronic device 200 includes components 205 and flex points 210. In one embodiment, flex points 210 may be provided at certain areas of flexible electronic device 200 to allow flexible electronic device 200 to bend or fold along, or relative to, each flex point 210. Flex points 210 may be points, lines, curves, areas, etc. as necessary and/or desired to achieve the desired flexibility.

In one embodiment, a flex point may exist at an area that is thinner than the surrounding areas, thereby increasing flexibility at that point. An example of such a flex point is an area that has been scored. Another example of such a flex point is an area in which material has been removed.

In another embodiment, a flex point may exist at an area where a material that is more flexible than the surrounding area is used.

In yet another embodiment, a flex point may exist at an area that has been made discontinuous, e.g., cut, severed, etc.

Other types of flex points and ways of increasing flexibility at flex points may be used as necessary and/or desired.

In one embodiment, components 205 may be placed between flex points 210 so as not to interfere with flex points 210. In another embodiment, only components 205 that are rigid may be placed in areas between flex points 210 to not interfere with flex points 210. The number of flex points 210 and the spacing between these flex points 210 may be selected as necessary and/or desired.

Referring to FIG. 2b, flexible electronic device 200 may also include flex points 210 that are positioned vertically and horizontally. In still another embodiment, flex points 210 may be positioned non-orthogonally, on a curve, etc. In sum, flex points 210 may have any suitable orientation as necessary and/or desired.

In one embodiment, a greater number of flex points 205 may be provided in the interior of the flexible electronic device 200. In one embodiment, flex points 210 do not have to run the length or width of flexible electronic device 200, but may exist only at one or both edges, in the middle, etc. Any configuration for flex points 210 may be used as necessary and/or desired.

In one embodiment, the number, orientation, and/or direction of flex points 210 may be selected so as to provide an approximation of continuous flexing to a user. In one embodiment, flex points 210 do not have to be provided through all layers of flexible electronic device 200. For example, a flex point may be provided toward at the upper (when viewed from the top) surface of flexible electronic device 200, but not near the lower surface.

The amount of bending, or flexing, at each flex point 210 may be predetermined and/or controlled. In one embodiment, strain gauges 220 may be provided. Any suitable number of strain gauges 220 may be provided, at any suitable orientation. In one embodiment, the resistance provided by strain gauges 220 may be pre-set; in other embodiments, the resistance provided by strain gauges 220 may be varied, for example, electronically. Each strain gauge 220 may operate independently of other strain gauges.

In one embodiment, a user may be notified when a predetermined amount of stress is applied to strain gauges 220. For example, the user may be warned not to bend flexible electronic device 200 further by an audible mechanism (e.g., a buzzer, chime, ringer, verbal warning, etc.), by a visual mechanism (e.g., a warning provided in display, illuminating a light, etc.), or by a physical mechanism (e.g., shaking, vibrations, etc.). In one embodiment, these tolerances may be pre-set in flexible electronic device 200; in another embodiment, a user may be able to set his or her own preferences for these tolerances. This may be particularly useful in one embodiment as flexing flexible electronic device 200 may function as a user input to, for example, change the page of an electronic book.

Examples of suitable strain gauges include those available from Micro-Flexitronics Limited, Coleraine, Northern Ireland.

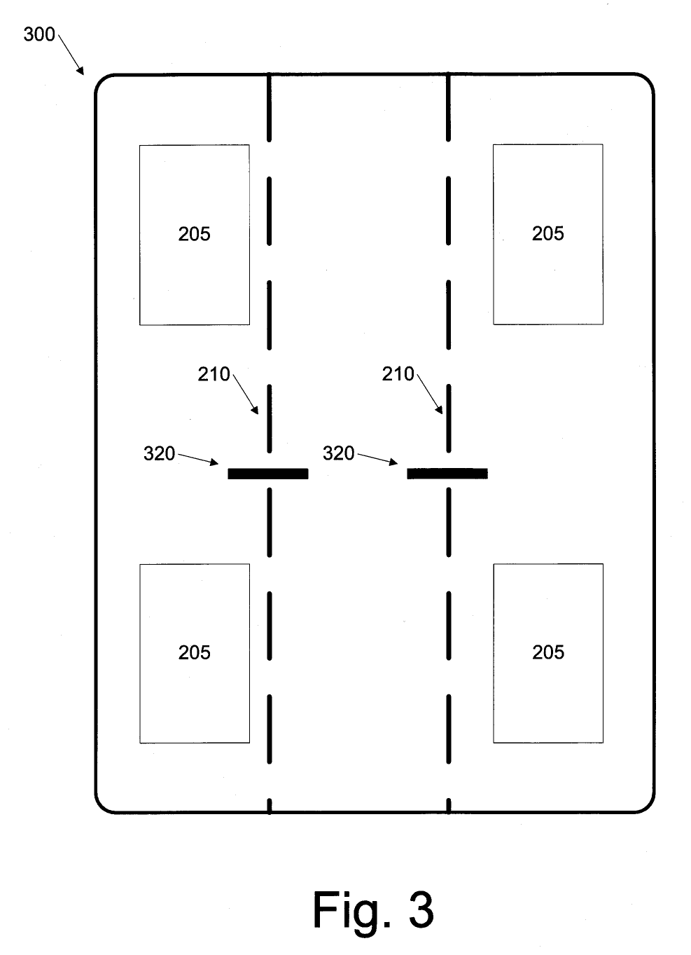

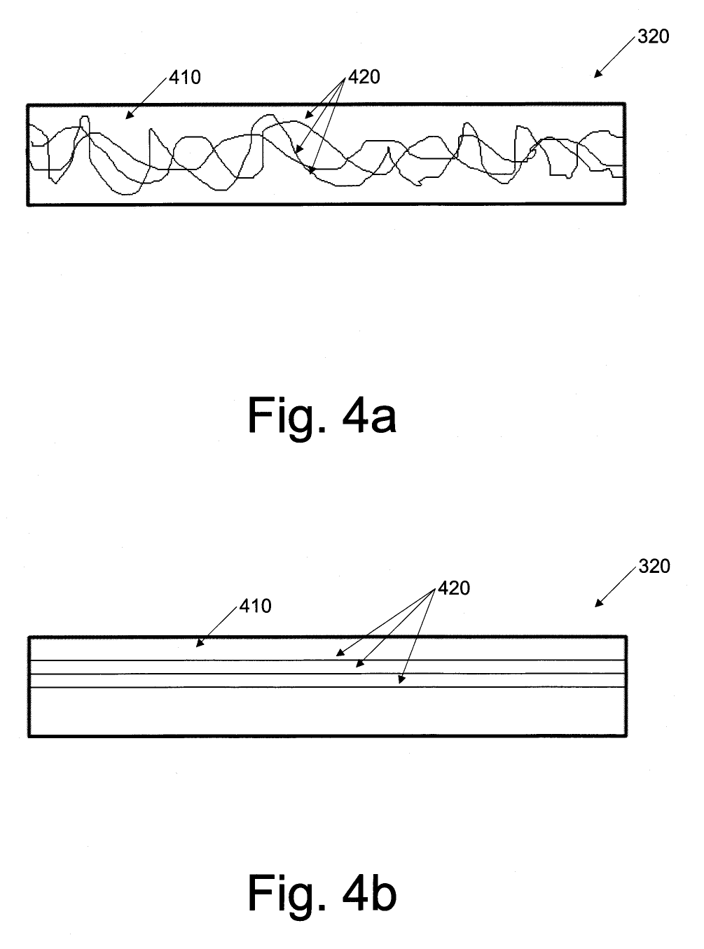

In another embodiment, referring to FIG. 3, carbon fiber “strings” 320 may be used to limit the amount of flexing that is possible at flex points 210. Referring to FIGS. 4a and 4b, a greatly simplified example of carbon fiber string 320 according to one embodiment is illustrated. Carbon fiber strings 320 may be formed by casting carbon fibers 420 in, for example, polymer 410. When cast, carbon fibers 420 may have a non-linear orientation—for example, they may be cast in a sinusoid, in a zig-zag, etc. This is illustrated in FIG. 4a.

When a force is exerted on the ends of carbon fiber strings 320 to extend or bend carbon fiber strings 320, carbon fibers 420 within carbon fiber strings 320 straighten, and ultimately prevent further bending. This is illustrated in FIG. 4b. In one embodiment, the resistance to bending may increase as the amount of force is increased; in another embodiment, the resistance may remain consistent up to the point at which no additional bending is permitted.

The amount of bending of carbon fiber strings 320 may be monitored by, for example, measuring resistance along carbon fibers 420. As with strain gauges 220, the user may be notified when a certain threshold of bending is reached by carbon fiber strings 320. Further, carbon fiber strings 320 may also serve as an input to flexible electronic device 300.

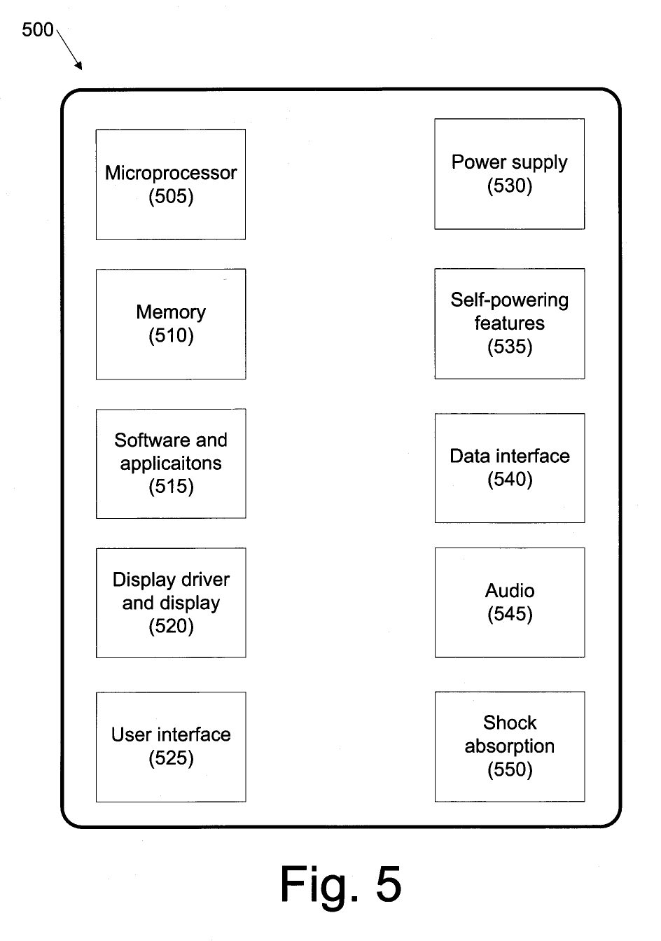

Referring to FIG. 5, a block diagram of a flexible electronic device according to one embodiment of the present invention is provided. Flexible electronic device 500 includes processor 505, memory 510, software and applications 515, display and drivers 520, user interface 525, power supply 530, self-powering features 535, data interface 540, audio capability 545, and shock absorption 550. Each of these elements will be described in greater detail below.

Processor 505 provides the processing power for flexible electronic device 500. Processor 505 may be any suitable processor or integrated circuit, including microprocessors, programmed microprocessors micro-controllers, peripheral integrated circuit elements, CSICs (Customer Specific Integrated Circuit) or ASICs (Application Specific Integrated Circuit), logic circuits, digital signal processors, programmable logic devices such as FPGAs, PLDs, PLAs or PALs, or any other device or arrangement of devices that is capable of performing the functions described herein.

Suitable microprocessors are available from Texas Instruments (e.g., the OMAP family) and Marvell Technology Group (e.g., the Discovery Innovation series, Xscale, etc). Other types and sources of microprocessors may be used as necessary and/or desired.

In one embodiment, processor 505 may be thinned to increase its flexibility.

Memory 510 may be any suitable memory, and may be used to store software and applications 515. Memory 510 may be volatile or non-volatile as necessary and/or desired. Memory 510 may include static RAM, dynamic RAM, flash memory, magnetic memory, etc.

In general, processor 505 and memory 510 may be mostly inflexible components. As such, processor 505 and memory 510 may be positioned in areas of flexible electronic device 500 that are not subject to significant bending. For example, processor 505 and memory 510 may be positioned in areas between flex points discussed above.

Processor 505 and memory 510 may be mounted on a printed circuit board by using an anisotropic conducting adhesive. In one embodiment, the printed circuit boards included in flexible electronic device 500 are flexible printed circuit boards.

Software and applications 515 may be provided for the user. The actual software and applications 515 provided depends on the application for flexible electronic device 500. In one embodiment, software and applications 515 may include software necessary to provide a flexible electronic book. In another embodiment, software and applications 515 may include software necessary to provide a flexible digital music player. In yet another embodiment, software and applications 515 may include software necessary to provide a flexible laptop computer. The appropriate software and applications 515 may be provided as necessary and/or desired.

In one embodiment, software and applications 515 further include software for operating flexible electronic device 500, including controllers for the various components, drivers, user interface, operating system, etc. For example, software and applications 515 may include self-diagnostic software that detects and attempts to repair or compensate for errors in the hardware or software. An example of this is battery management software that monitors the status of the rechargeable batteries. When the useful lifetime of a rechargeable battery has been exhausted, the battery management software may disable the exhausted rechargeable battery and switch to a subsequent rechargeable battery. This may eliminate, or reduce, the need to open the hermetically sealed case for flexible electronic device 500.

Display and drivers 520 are provided for displaying characters, graphics, videos, pictures, etc. for the user. In one embodiment, the display may be a flexible display. Suitable examples technologies for manufacturing such display include EPLaR (Electronics on Plastic by Laser Release), developed by Philips Research, SUFTLA, developed by EPSON, and electronic ink, developed by E-Ink Corp. An example of a suitable flexible display is available from LG Philips LCD.

Other technologies, including Organic LED (OLED) displays, may also be used as necessary and/or desired.

The display is operated by driver chips. In general, driver chips may be located on the edges of the display; because of this, in one embodiment, the driver chips may be thinned so that they are flexible. In one embodiment, the driver chips may have a thickness of 12 microns.

In one embodiment, the driver chips may be replaced by integrating the driver transistors into the display. In this embodiment, the drivers transistors will generally be located around the edges of the display, but will be manufactured as part of the screen in, for example, the substrate (e.g., the metal foil, plastic, etc.).

In one embodiment, the display may be a touch-sensitive screen. This may be achieved by including sensors (e.g., vibration sensors) around the edges of the display that monitor for acoustic waves indicating that the display was touched. Based on the sensors, the actual location of the touch may be calculated by, for example, triangulation.

Due to the flexibility of the display, the touch-sensitive screen may need to be periodically calibrated. In one embodiment, data from the strain gauges, carbon fiber strings, etc. may be used to continuously calibrate the touch-sensitive screen. In another embodiment, data from the strain gauges, carbon fiber strings, etc. may be used in the calculation for the location of the touch on the touch screen.

In another embodiment, a user may be able to use a stylus to “write” or point to objects on the display.

Other input devices, such as levels, accelerometers, etc. may be used as necessary and/or desired.

User interface 525 may be provided for the user to interact with flexible electronic device 500. Any suitable input mechanism may be provided. In one embodiment, buttons may be provided. In another embodiment, as discussed above, a touch-sensitive screen may be provided. In still another embodiment, and as discussed above, sensors may be provided that sense that flexible electronic device 500 is being flexed, or bent. In yet another embodiment, a microphone may be provided to detect speech. In another embodiment, a camera may be provided. Other inputs may be provided as necessary and/or desired, depending on application.

Flexible electronic device 500 may be powered by power supply 530. In one embodiment, at least one flexible rechargeable battery may be provided.

In one embodiment, multiple rechargeable batteries may be provided. As the useful life of each rechargeable battery is exhausted, the control circuitry of flexible electronic device switches to the next rechargeable battery. Thus, it is not necessary to open flexible electronic device 500 to replace the exhausted battery.

In one embodiment, the rechargeable batteries may be charged by inductive charging. In another embodiment, one rechargeable battery may be used while a second rechargeable battery is being charged.

The battery compartment may be provided with a one-way valve to permit the release of gas pressure as the rechargeable battery is used.

The rechargeable battery may be made by a lamination process, and may be assembled as the layers of flexible electronic device 500 are assembled.

Flexible electronic device 500 may include self-powering features 535. In one embodiment, at least one piezoelectric material may be provided in flexible electronic device 500 to function as a generator. In one embodiment, the piezoelectric material may be provided in at least one strip that crosses at least one flex point.

By flexing flexible electronic device 500, a user may be able to generate electricity to provide power to or to charge batteries for flexible electronic device 500. In one embodiment, a user may provide some or all of the required power to flexible electronic device 500 just by operating flexible electronic device 500 in a normal manner.

In one embodiment, self-powering features 535 may allow a user to charge power supply 530 by flexing flexible electronic device 500.

Flexible electronic device 500 is provided with data interface 540. In one embodiment, data interface may be any suitable wireless communication method, including radio frequency (RF), infrared (IR), Bluetooth, near field communication, WiFi (e.g., any suitable IEEE 802.11 protocol), etc.

In one embodiment, data interface 540 may be integrated with power supply 530 so that data can be transmitted using inductive coupling. In one embodiment, this may occur during inductive charging. This may be achieved through, for example, a modulation and demodulation process.

Other mechanisms for providing data to flexible electronic device 500 via data interface 540 may be used as necessary and/or desired.

Audio capability 545 may be provided. In one embodiment, because flexible electronic device 500 is sealed, a speaker and at least one audio resonant cavity is provided. The audio resonant cavity amplifies the waves produced by the speaker so that they are audible outside of flexible electronic device 500.

In one embodiment, the audio resonant cavities may be flat channels formed in one or more layers of flexible electronic device 500.

Flexible electronic device 500 may be provided with other layers. For example, as discussed above, flexible electronic device 500 may be provided with at least one shock absorption layer. In one embodiment, this may be a shock absorbing gel or combination of gels.

Other layers, including heat sink layers, adhesive layers, etc. may be used as necessary and/or desired.

In one embodiment, the flexible printed circuit boards on different layers of the flexible electronic device may communicate with each other. In one embodiment, this may be achieved by providing the flexible printed circuit boards with electrical pads that overlap, and providing the flexible printed circuit boards with electrical pads that overlap, and providing an anisotropic conducting adhesive between the electrical pads.

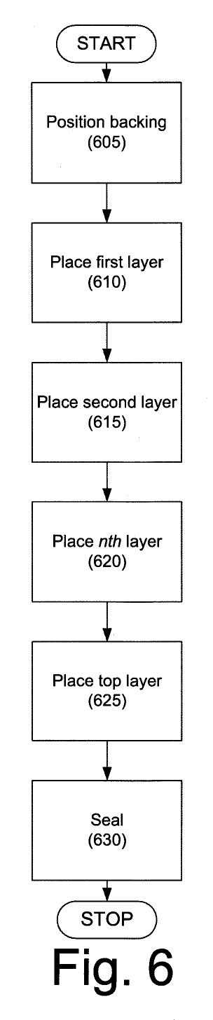

Referring to FIG. 6, a method of assembly of a flexible electronic device according to one embodiment of the present invention is provided. In step 605, the backing layer for the flexible electronic device is positioned. In one embodiment, backing may be a layer of flexible plastic. Further, backing layer may have a concave shape.

In step 610, a first layer is positioned on backing layer. In one embodiment, first layer may be an adhesive layer. In another embodiment, first layer may be a shock absorbing layer. In yet another embodiment, first layer may be a layer of components. In still another embodiment, first layer may be a combination of any of the above-mentioned features.

In step 615, a second layer is positioned on the first layer. Like the first layer, the second layer may be an adhesive layer, a shock absorbing layer, a layer of components, or a combination thereof.

In step 620, the process is repeated for the n layers that comprise the interior of the flexible electronic device. The number of layers may depend on, for example, the type of flexible electronic device, the features to be included in the flexible electronic device, the size of the flexible electronic device, etc.

In step 625, the front layer is positioned over the nth layer. In one embodiment, the front layer may be a clear plastic layer. The front layer may also be concave and may be configured to mate with the backing layer.

In step 630, the adhesive layers are cured. In one embodiment, this may occur as each layer is assembled, or after multiple layers are assembled. In another embodiment, multiple curing techniques may be applied to the same layer. In still another embodiment, the curing may be performed after the flexible electronic device is sealed.

Depending on the adhesives used in the flexible electronic device, more than one type of curing may be used. As noted above, curing may be achieved by several techniques, including ultrasound, RF, heat, etc.

In step 635, the flexible electronic device is sealed. In one embodiment, the flexible electronic device may be substantially hermetically sealed. In another embodiment, the flexible electronic device may be completely hermetically sealed.

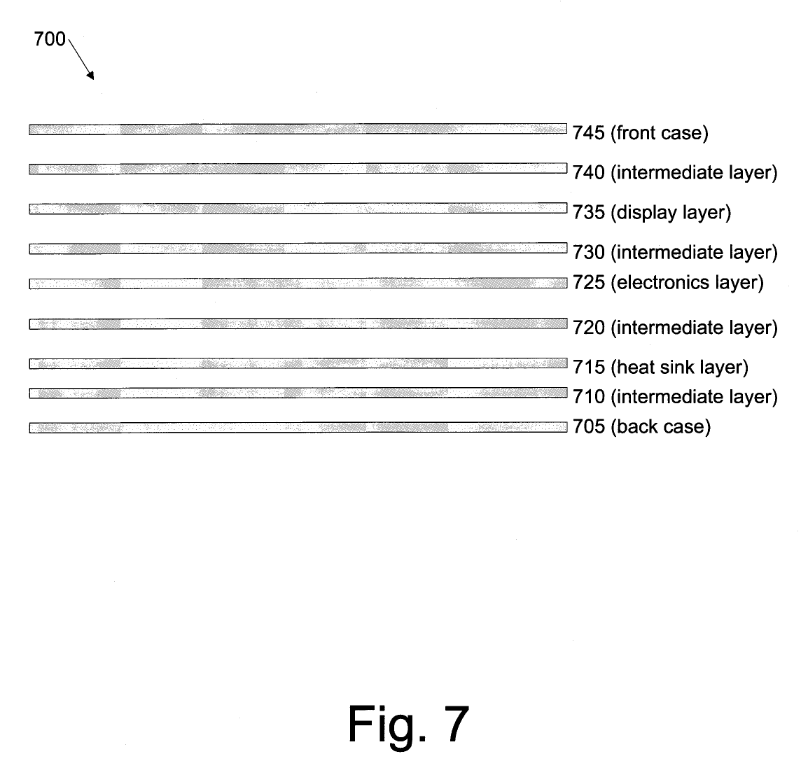

Referring to FIG. 7, an exemplary cross section of a flexible electronic device is provided. Flexible electronic device included back case 605, intermediate layers 710, 720, 730, 740, heat sink layer 715, electronics layer 725, display layer 735, and front case 745. In one embodiment, intermediate layers 710, 720, 730, 740 may be adhesive layers, shock absorbing layers, heat sink layers, or a combination.

It should be recognized that greater or fewer number of layers may be provided as necessary and/or desired. It should also be recognized that, although FIG. 6 illustrates each layer has having a certain function, a layer may have multiple functions. For example, a layer may provide electronics and display functionality. Another example is that a layer may provide the acoustic cavity and rechargeable battery. Still another example is a layer providing electronics and shock absorption functionality. Any combination of functionalities may be provided as necessary and/or desired.

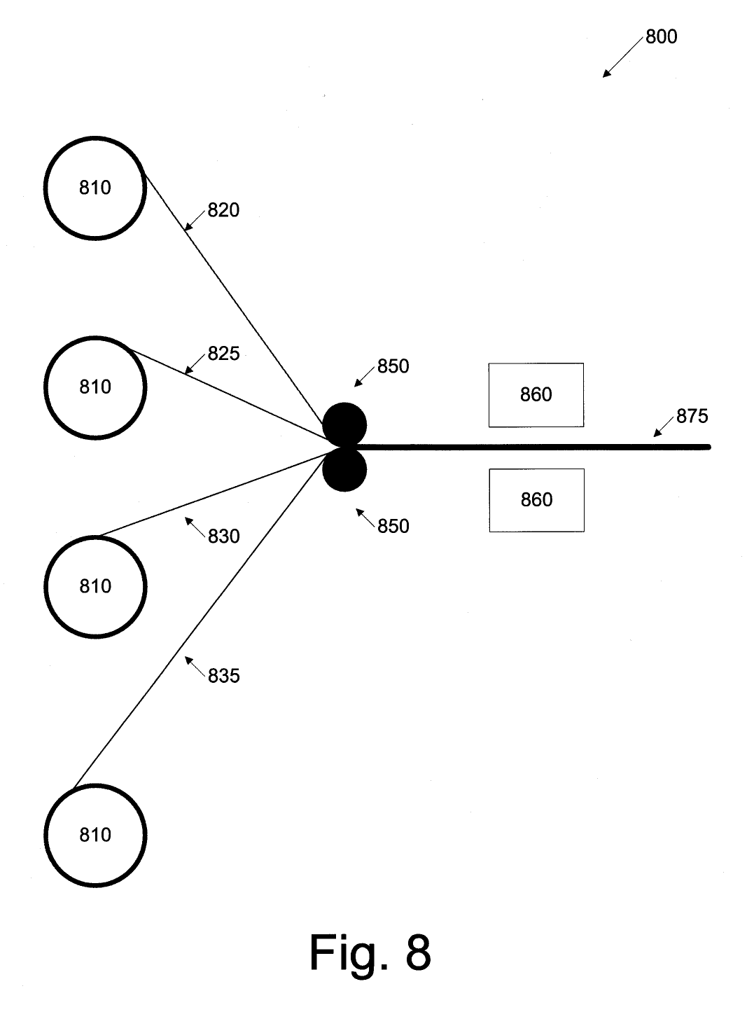

Referring to FIG. 8, example of system 800 for manufacturing a flexible electronic device by lamination is provided. In one embodiment, at least one roller 810 provide the “stock” of each layer or layers that will be laminated, resulting in become the flexible electronic device laminate 875. For example, one roller 810 may contain a continuous sheet of front portions 815 for the flexible electronic device, one roller 810 may contain a continuous sheet of shock absorption/adhesive layer 825 for the flexible electronic device, one roller 810 may contain a continuous sheet of electronics (e.g., flexible printed circuit board, etc.) 830 for the flexible electronic device, and so on. The last roller 810 may contain a continuous sheet of back portions 835 for the flexible electronic device. The number of rollers 810 may depend on the number of layers, etc.

In one embodiment, inflexible (or mostly inflexible) components may be provided for a particular layer after the layer is unrolled from roller 810. This may involve automated or manual positioning of the component(s) on the layer.

Rollers 850 may be provided to combine layers 820, 825, 830, 835 etc. that comprise the flexible electronic device into laminate 875. In one embodiment, rollers 850 may press the layers together.

Curing (e.g., ultrasound, RF, heat, etc.) may be performed by curing device 860.

Laminate 875 may be separated into individual flexible electronic devices. In one embodiment, laminate 875 may be rolled onto a roller (not shown) for storage. The diameter of this roller may depend on, for example, the flexibility of the laminate.

In one embodiment, multiple lamination stages may be employed. For example, in one embodiment, instead for being provided from roller 810, layer 830 may itself be a laminate that is the output of a combination of a lamination process. This may be particularly useful when, for example, different types of curing are used due to the components.

Additional processing (e.g., sealing, polishing, etc.) may be employed as necessary and/or desired.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, light pen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A flexible electronic device, comprising:
a front;
a back;
a plurality of layers disposed between the front and the back;
a plurality of components disposed on the layers, the components including at least a processor, a memory, a display, a display driver, a battery, and a data interface; and
a plurality of flex points, wherein the flexible electronic device can be flexed relative to each flex point.

2. The flexible electronic device of claim 1, wherein at least one of the plurality of components is an inflexible component.

3. The flexible electronic device of claim 1, wherein the inflexible component is positioned between flex points.

4. The flexible electronic device of claim 1, wherein at least one of the plurality of components is a thinned component.

5. The flexible electronic device of claim 1, wherein the battery is charged by induction.

6. The flexible electronic device of claim 1, further comprising:
a flex limitation device disposed across at least one of the flex points.

7. The flexible electronic device of claim 6, wherein the flex limitation device is at least one of a strain gauge and a carbon fiber string.

8. The flexible electronic device of claim 1, further comprising at least one piezoelectric strip that generates power when the flexible electronic device is flexed.

9. The flexible electronic device of claim 1, wherein the flexible electronic device is hermetically sealed.

10. The flexible electronic device of claim 1, wherein the data interface uses inductive coupling.

11. The flexible electronic device of claim 1, further comprising:
a speaker; and
at least one audio resonant cavity formed in at least one of the layers.

12. The flexible electronic device of claim 1, wherein at least one of the layers is an adhesive layer.

13. The flexible electronic device of claim 1, wherein at least one of the layers is a shock absorption layer.

14. A method of manufacturing a flexible electronic device by lamination, comprising:
providing a first source of front layers for the flexible electronic device;
providing a second source of back layers for the flexible electronic device;
providing a source for each interior layer of the flexible electronic device, at least one interior layer having at least one flexible electronic component disposed thereon;
pressing the front, interior, and back layers together, resulting in a laminate; and
curing the laminate.

15. The method of claim 14, wherein at least one of the interior layers comprises an inflexible component disposed between flex points on the interior layer.

16. The method of claim 14, wherein the interior layers comprise a processor, a memory, a display, a display driver, a battery, and a data interface.

17. The method of claim 15, wherein the battery is disposed among a plurality of the interior layers.

18. The method of claim 14, wherein at least one of the interior layers comprises a flex limitation device disposed across at least one of the flex points.

19. The method of claim 14, wherein at least one of the interior layers comprises at least one piezoelectric strip that generates power when the flexible electronic device is flexed.

20. A laminate flexible electronic device, comprising:
a front layer;
a back layer;
a plurality of interior layers disposed between the front layer and the back layer; and
a plurality of components including at least a processor, a memory, a display, a display driver, a battery, and a data interface;
wherein the front layer, the interior layers, and the back layer are laminated together.
